(19) United States
(12) Patent Application Publication
(10) Pub. No.: US 2025/0009177 A1
(43) Pub. Date: Jan. 9, 2025

(54) MULTI-ZONE INDEPENDENT COMBUSTION AND MIXED HEAT SUPPLY COMBUSTION DEVICE AND GRILL

(71) Applicant: NINGBO AGSUN PRODUCTS,INC., CIXI (CN)

(72) Inventors: Jinsheng Wu, CIXI (CN); Binhang Sun, CIXI (CN); Xuefei Mao, CIXI (CN); Xianghua Liu, CIXI (CN); Junye Mi, CIXI (CN)

(21) Appl. No.: 18/891,055

(22) Filed: Sep. 20, 2024

(30) Foreign Application Priority Data
Jun. 20, 2024 (CN) 202421421846.8

(51) Int. Cl. A47J 37/07

(52) U.S. Cl. CPC A47J 37/0754; A47J 37/0704

(57) ABSTRACT

The present invention discloses a multi-zone independent combustion and mixed heat supply combustion device and a grill, where each fuel is independently combusted in a first combustion chamber and a second combustion chamber, and when an airflow in an air duct flows through the first combustion chamber and the second combustion chamber by means of a blowing device, heat generated by combustion is taken away and flows out of a heat flow outlet to realize multi-zone independent combustion and mixed heat supply.

### TECHNICAL FIELD

The present invention belongs to the field of grills, and specifically pertains to a multi-zone independent combustion and mixed heat supply combustion device and a grill.

### BACKGROUND

Grills are a type of devices that bake and cook food in the form of hot air, and generally in closed or semi-closed structures. Traditional grills are heated by burning wood and coal. Modern grills have multiple functions, and are subject to electric heating or gas heating.

A traditional grill is typically provided with a combustion cavity under a grilling net, so that fuels such as wood and coal are fed in the combustion cavity for combustion, and heat flow generated by the combustion of the fuels rises to grill the food on the grilling net located above. Typically, a plurality of fuels are used simultaneously, and two combustion modes are available for the plurality of fuels.

In the first mode, the fuels are burned in a mixed state, so that the fuels are centrally burned, and the heat flow generated by the fuels is in a completely mixed state, and the food on the grilling net located above is grilled by the completely mixed heat flow.

In the second mode, the fuels are separately burned at a small spacing, so that the fuels are burned in respective zones, and the heat flow generated by the fuels are partially mixed during respective rise, and the food on the grilling net located above is grilled by a plurality of unmixed heat flows and the partially mixed heat flow.

The above first combustion mode has disadvantages in that: 1. different fuels require different cleaning methods, and the fuels in the mixed state need to be classified again during subsequent cleaning, resulting in inconvenient cleaning; 2. there is only one combustion state for the fuels in the mixed state, so it is impossible to determine combustion conditions of different fuels; and 3. the mixed fuels interact with each other during combustion, and different mixing ratios result in different impacts, resulting in unstable combustion states of the fuels.

The above second combustion mode has disadvantages in that: the heat flows generated by different fuels have different states, and the heat flows of a plurality of different states generated by separate combustion result in uneven heating of the grilling net located above.

### SUMMARY

In view of the deficiencies of the prior art, it is an object of the present invention to provide a multi-zone independent combustion and mixed heat supply combustion device and a grill, where each fuel is independently combusted in a first combustion chamber and a second combustion chamber, and when an airflow in an air duct flows through the first combustion chamber and the second combustion chamber by means of a blowing device, heat generated by combustion is taken away and flows out of a heat flow outlet to realize mixed heat supply.

In order to achieve the above object, the present invention provides the following technical solutions.

A multi-zone independent combustion and mixed heat supply combustion device, includes: a combustion bin provided with an air duct therein, where a first combustion chamber and a second combustion chamber are formed in the air duct, the first combustion chamber and the second combustion chamber are configured for fuel combustion to be heated, and a heat flow outlet is formed at an end of the air duct; and a blowing device operative to blow an airflow into the air duct, where the airflow sequentially passes through the first combustion chamber and the second combustion chamber to be heated to form hot air and is discharged from the heat flow outlet.

Preferably, a temperature of the first combustion chamber in a combustion state is lower than a temperature of the second combustion chamber in the combustion state.

In some embodiments, a size of a bin of the first combustion chamber is smaller than a size of a bin of the second combustion chamber to achieve the purpose of having the temperature of the first combustion chamber lower than that of the second combustion chamber in the combustion state.

In further embodiments, a fuel holding density of the first combustion chamber is smaller than a fuel holding density of the second combustion chamber to achieve the purpose of having the temperature of the first combustion chamber lower than that of the second combustion chamber in the combustion state.

In some other embodiments, a combustion heat value of a combustion product introduced into the first combustion chamber is lower than a combustion heat value of a combustion product introduced into the second combustion chamber, which can also achieve the purpose of having the temperature of the first combustion chamber lower than that of the second combustion chamber in the combustion state.

By using the above technical solutions, two different fuels such as wood pellets and charcoal can be respectively introduced into the first combustion chamber and the second combustion chamber for combustion, so that a large amount of heat is generated in the first combustion chamber and the second combustion chamber by combustion, and the airflow in the air duct sequentially passes through the first combustion chamber and the second combustion chamber during the combustion by means of the blowing device to take away hot air in the first combustion chamber and the second combustion chamber, and the hot air is mixed when the airflow flows to the heat flow outlet, which ensures uniform temperature of the airflow, and finally the mixed airflow flow out of the heat flow outlet for heating. Here, due to independent combustion of the fuels, not only can the residual fuels be cleaned separately without classification, which results in convenient cleaning, but also the combustion of each fuel can be observed separately to determine combustion condition of each fuel more accurately, and the fuels do not interfere with each other, which ensure more stable combustion of each fuel. Moreover, since different fuels can be fed simultaneously, the combustion of the wood pellets produce the aroma of fruit wood, while the combustion of the charcoal produces a charcoal grilled flavor, and the two flavors are uniformly mixed to achieve uniform multi-flavored grilling of the grilled food.

As a second aspect of the present invention, there is also provided a grill including a hob and a multi-zone independent combustion and mixed heat supply combustion device described above, where the combustion device is arranged on the hob to supply heat.

In some embodiments, the hob is provided with a braising and roasting cavity thereon, and a heat flow outlet of the combustion device is in communication with the braising and roasting cavity. In further embodiments, the hob is provided thereon with a heating cavity and a grilling net located above the heating cavity, and the heat flow outlet of the combustion device is in communication with the heating cavity.

### BRIEF DESCRIPTION OF THE DRAWINGS

In order to illustrate the technical solutions of the embodiments of the present invention or the prior art more clearly, the drawings to be used in the description of the embodiments or the prior art will be briefly described below. Obviously, the drawings in the following description are only some embodiments of the present invention. a person of ordinary skill in the art can obtain other drawings based on these drawings without making any creative effort. For those having ordinary skill in the art, other drawings can be obtained from these drawings without creative efforts.

FIG. 1 is an assembly view of Embodiment I of the present invention;

FIG. 2 is a cross-sectional view of Embodiment I of the present invention;

FIG. 3 is an exploded view of Embodiment I of the present invention;

FIG. 4 is a structural schematic view of a portion of Embodiment I of the present invention;

FIG. 5 is a schematic view of a combustion box in Embodiment I of the present invention;

FIG. 6 is a schematic view of a bin cover in Embodiment I of the present invention;

FIG. 7 is a schematic view of a combustion-supporting member in Embodiment I of the present invention;

FIG. 8 is an assembly view of Embodiment II of the present invention;

FIG. 9 is a cross-sectional view of Embodiment II of the present invention; and

FIG. 10 is a cross-sectional view of Embodiment III of the present invention.

Reference numerals in the drawings: 1. combustion bin;
11. air duct; 12. combustion cavity; 13. extension section; 14. disassembly port; 15. heat-conducting member;
111. first air duct; 112. second air duct; 113. third air duct; 119. heat flow outlet; 121. first combustion chamber; 122. second combustion chamber; 123. first upper cavity; 124. second upper cavity;
2. blowing device;
21. mounting bracket; 22. fan motor;
31. first separator; 32. second separator; 33. first bending guide rail; 34. first sliding portion; 35. second bending guide rail; 36. second sliding portion;
4. bin cover;
5. combustion box;
51. first fuel bin; 52. second fuel box;
61. first communication hole; 62. second communication hole; 63. third communication hole; 64. fourth communication hole;
7. ash box;
8. combustion-supporting member;
81. support base; 82. limiting side wall; 83. hanging portion; 84. limiting portion; 85. combustion-supporting cavity;
9. hob;
91. braising and roasting cavity; 92. heating cavity; 93. box cover; 94. net rack; 95. support rod; 96. grilling net.

### DESCRIPTION OF THE EMBODIMENTS

### Embodiment I

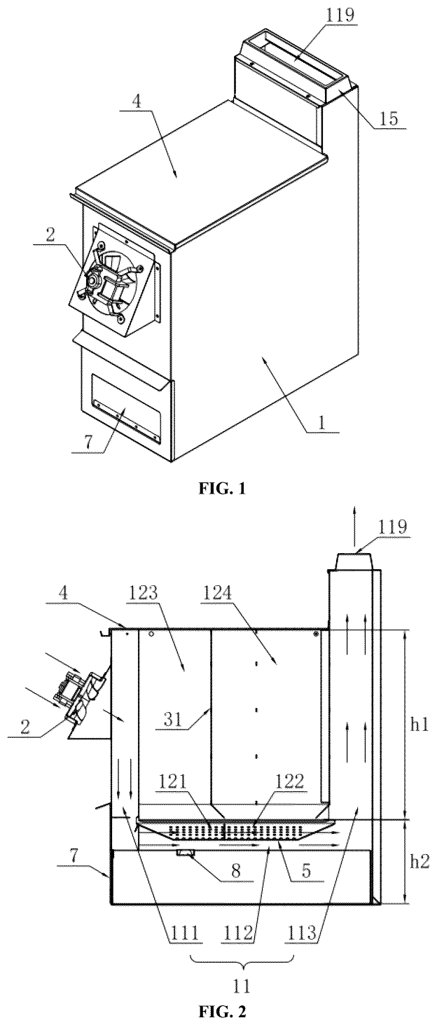

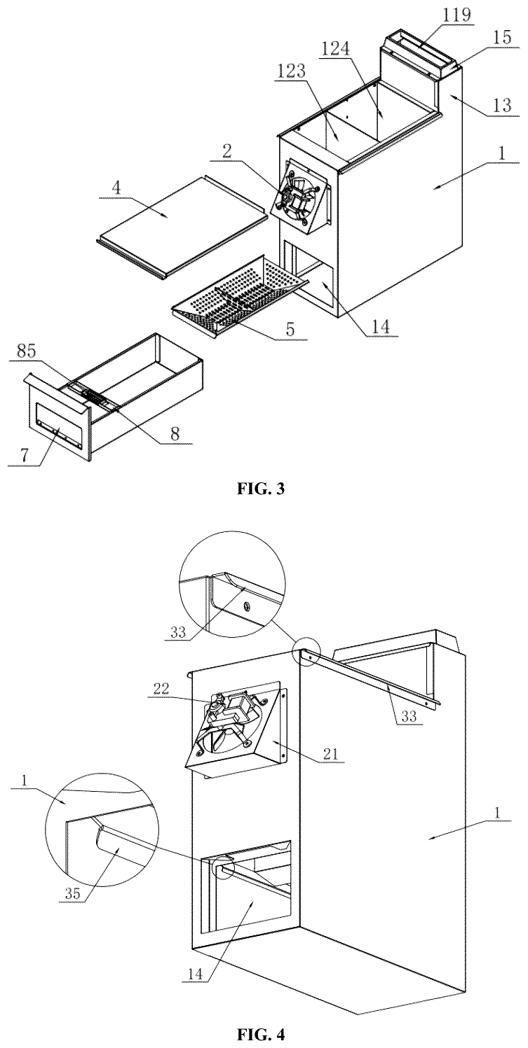

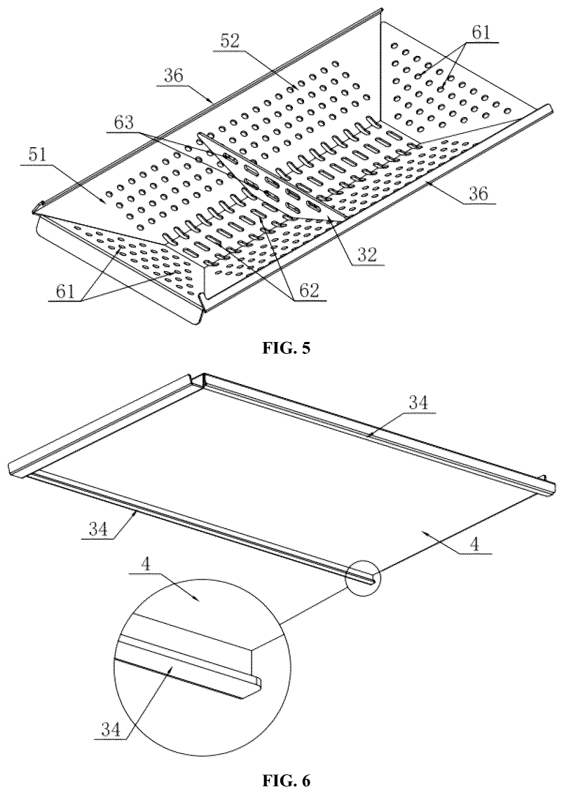

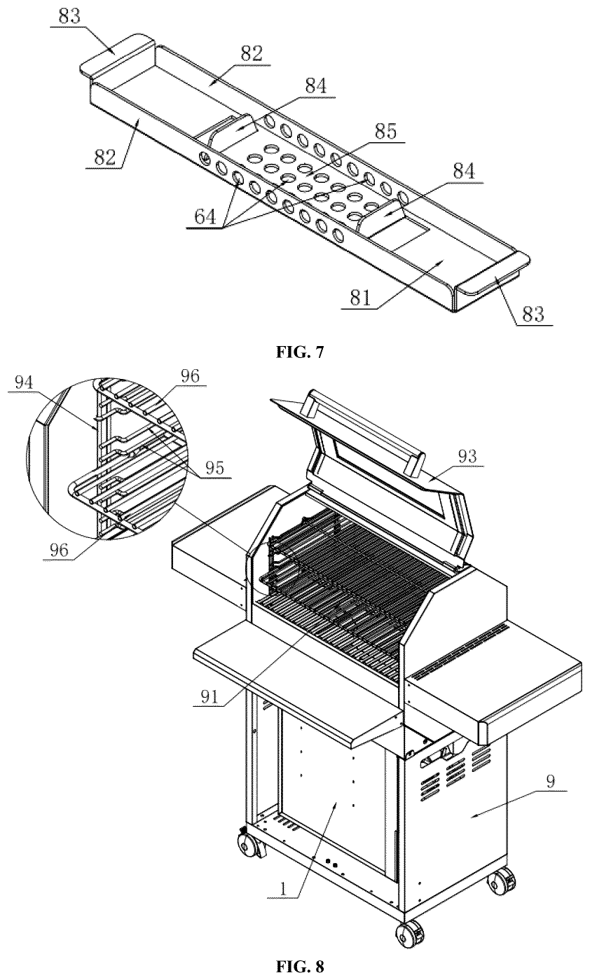

As shown in FIGS. 1-7, the present invention discloses a multi-zone independent combustion and mixed heat supply combustion device, including:
a combustion bin 1 formed by splicing a plurality of plates together using riveting, welding and other methods and having a cuboid outer peripheral shape as a whole, where the combustion bin 1 is provided therein with an air duct 11 and a first combustion chamber 121 and a second combustion chamber 122 which are separated, the first combustion chamber 121 and the second combustion chamber 122 are configured for fuel combustion to be heated, and a heat flow outlet 119 is provided at an end of the air duct 11; and
a blowing device 2 operative to blow an airflow into the air duct 11, where the airflow sequentially passes through the first combustion chamber 121 and the second combustion chamber 122 to be heated to form hot air and is discharged from the heat flow outlet 119.

Therefore, two different fuels such as wood pellets and charcoal can be respectively introduced into the first combustion chamber 121 and the second combustion chamber 122 for combustion, so that a large amount of heat is generated in the first combustion chamber 121 and the second combustion chamber 122 by combustion, and the airflow in the air duct 11 sequentially passes through the first combustion chamber 121 and the second combustion chamber 122 during the combustion by means of the blowing device 2 to take away hot air in the first combustion chamber 121 and the second combustion chamber 122, and the hot air is mixed when the airflow flows to the heat flow outlet 119, which ensures uniform temperature of the airflow, and finally the mixed airflow flow out of the heat flow outlet 119 for heating. Here, due to independent combustion of the fuels, not only can the residual fuels be cleaned separately without classification, which results in convenient cleaning, but also the combustion of each fuel can be observed separately to determine combustion condition of each fuel more accurately, and the fuels do not interfere with each other, which ensure more stable combustion of each fuel. Moreover, since different fuels can be fed simultaneously, the combustion of the wood pellets produce the aroma of fruit wood, while the combustion of the charcoal produces a charcoal grilled flavor, and the two flavors are uniformly mixed to achieve uniform multi-flavored grilling of the grilled food.

Preferably, a temperature of the first combustion chamber 121 in a combustion state is lower than a temperature of the second combustion chamber 122 in the combustion state. Therefore, the airflow passing through the first combustion chamber 121 and the second combustion chamber 122 is gradually heated up, resulting in a positive temperature gradient and high heat energy transfer efficiency.

Here, in order to achieve a lower temperature of the first combustion chamber 121 in the combustion state than that of the second combustion chamber 122 in the combustion state, the following methods can be used: the first method is to provide a smaller size of a bin (i.e., a first fuel bin 51 described later) of the first combustion chamber 121 than that of a bin (i.e., a second fuel bin 52 described later) of the second combustion chamber 122 as shown in the drawings, so that the fuel that can be accommodated in the first combustion chamber 121 is less than the fuel that can be accommodated in the second combustion chamber 122, so that the second combustion chamber 122 generates more heat during combustion, so that the temperature of the second combustion chamber 122 in the combustion state is higher than that of the first combustion chamber 121; the second method is to place less fuel in the first combustion chamber 121 than in the second combustion chamber 122, so that the second combustion chamber 122 generates more heat during combustion, so that the temperature of the second combustion chamber 122 in the combustion state is higher than that of the first combustion chamber 121; and the third method is to place a combustion product having a higher combustion heat value than a combustion product in the second combustion chamber 122 in the first combustion chamber 121, so that the second combustion chamber 122 generates more heat during combustion, so that the temperature of the second combustion chamber 122 in the combustion state is higher than that of the first combustion chamber 121. The above three methods can be used simultaneously, or any one or two can be used.

Specifically, the blowing device 2 consists of a mounting bracket 21 and a fan motor 22 provided on the mounting bracket 21, the mounting bracket 21 is mounted on the combustion bin 1, and the fan motor 22 operates to generate the airflow.

In other embodiments, one to three separate combustion cavities are also provided behind the second combustion chamber 121 for further partitioning, depending on usage requirements.

Specifically, in the present embodiment, the first combustion chamber 121 and the second combustion chamber 122 are arranged in a left-right arrangement, so that the airflow in the air duct 11 sequentially flows through the first combustion chamber 121 and the second combustion chamber 122 from left to right.

Moreover, the combustion bin 1 is provided with a first upper cavity 123 above the first combustion chamber 121 and a second upper cavity 124 above the second combustion chamber 122, and the first upper cavity 123 and the second upper cavity 124 are separated by a first separator 31. Moreover, the first upper cavity 123 and the second upper cavity 124 are in a sealed configuration so that the airflow is unable to be discharged through the first upper cavity 123 and the second upper cavity 124.

Therefore, fuels can be added to the first combustion chamber 121 and the second combustion chamber 122 when the first upper cavity 123 and the second upper cavity 124 are in an open state, and the fuel added to the first combustion chamber 121 and the fuel added to the second combustion chamber 122 cannot be mixed with each other in the presence of the first separator 31 to prevent mixed combustion. In addition, the arrangement of the first upper cavity 123 and the second upper cavity 124 can increase a distance between the first combustion chamber 121 and a refueling position and a distance between the second combustion chamber 122 and a refueling position, which can realize safe refueling; and more fuels can be added or long strips of firewood can be introduced by means of spaces of the first upper cavity 123 and the second upper cavity 124.

Here, in the present embodiment, the air duct 11 includes a first air duct 111 on a left side, a second air duct 112 on a lower side and a third air duct 113 on a right side, the first air duct 111 and the third air duct 113 are both arranged to extend vertically, and a lower end of the first air duct 111 is in communication with a left end of the second air duct 112; and a lower end of the third air duct 113 is in communication with a right end of the second air duct 112, so that the air duct 11 has a U-shaped structure as a whole.

In addition, the first combustion chamber 121 and the second combustion chamber 122 are arranged in the second air duct 112. Correspondingly, the first upper cavity 123 and the second upper cavity 124 are located between the first air duct 111 and the third air duct 113, and a left side of the first upper cavity 123 is attached to the first air duct 111, and a right side of the second upper cavity 124 is attached to the third air duct 113.

In addition, the blowing device 2 is located above a left side of the first air duct 111, so that the blowing device 2 blows the airflow into the first air duct 111, and the heat flow outlet 119 is located at an upper end of the third air duct 113.

Therefore, 1. the blowing device 2 is operative to blow the airflow outside the combustion bin 1 into the first air duct 111, the airflow flows downward in the first air duct 111 to the second air duct 112, and during flow, the first upper cavity 123 conducts heat to the left to preheat the airflow; 2. the airflow entering the second air duct 112 flows to the right and sequentially passes through the first combustion chamber 121 and the second combustion chamber 122, and takes away the heat generated by combustion in the first combustion chamber 121 and the second combustion chamber 122 through heat conduction while supplementing the first combustion chamber 121 and the second combustion chamber 122 with oxygen to ensure more complete combustion of the fuels, then the heated up airflow flows to the right to the third air duct 113; and 3, the airflow entering the third air duct 113 flows upward to the heat flow outlet 119, and during flow, the second combustion chamber 122 conducts heat to the right to maintain a high temperature in the third air duct 113 to reduce heat loss of the airflow, so that the airflow flowing out of the heat flow outlet 119 has such high temperature.

Here, in the present embodiment, upper ends of the first upper cavity 123 and the second upper cavity 124 are respectively provided with a feed port. Correspondingly, the combustion bin 1 is provided with a bin cover 4 above the first upper cavity 123 and the second upper cavity 124 for opening and closing the feed port, the bin cover 4 is opened to supplement fuel into the first upper cavity 123 and the second upper cavity 124 through the feed port. Specifically, front and rear sides of the combustion bin 1 are respectively provided with a first bending guide rail 33 extending left and right, and front and rear sides of the bin cover 4 are respectively provided with a first sliding portion 34 adapted to the first bending guide rail 33 in a bending manner, so that the bin cover 4 can slide left and right with the cooperation of the first sliding portion 34 and the first bending guide rail 33, and slides left to open the feed port and slides right to close the feed port.

Therefore, when it is necessary to add fuel, observe combustion in a combustion cavity 12, and clean the combustion cavity 12, the feed port is opened by sliding the bin cover 4 to the left, and after the operation is completed, the feed port is closed by sliding the bin cover 4 to the right.

Here, a right end of the combustion bin 1 is provided with an extension section 13 extending upward, and the heat flow outlet 119 is arranged above the extension section 13.

Thus, the arrangement of the extension section 13 not only allows the heat flow outlet 119 to be better lifted upward to align with the cavity that needs heating, but also restricts the sliding of the bin cover 4 to the right under the limit of the extension section 13.

Preferably, in the present embodiment, the upper ends of the first air duct 111, the first upper cavity 123 and the second upper cavity 124 are flush, and the bin cover 4 is arranged covering the upper ends of the first air duct 111, the first upper cavity 123 and the second upper cavity 124; and the first upper cavity 123 and the second upper cavity 124 have a height h1, the second air duct 112 has a height h2, and h1 is 3-10 times of h2.

Moreover, in the present embodiment, the combustion bin 1 is detachably provided with a combustion box 5 which is located in the second air duct 112 and has an open upper end. In addition, the combustion box 5 is provided with a second separator 32 therein to separate the combustion box 5 into a first fuel bin 51 located in the first combustion chamber 121 and a second fuel bin 52 located in the second combustion chamber 122. Therefore, the combustion box 5 is arranged so that the fuel is mainly concentrated in the first fuel bin 51 and the second fuel bin 52 in the combustion box 5 for combustion, and the second separator 32 effectively ensures separation between the first fuel bin 51 and the second fuel bin 52 and independent combustion of each fuel. After the combustion is completed, the remaining fuel in the combustion box 5 can be cleaned off more conveniently by removing the combustion box 5.

Specifically, in order to achieve a lower temperature of the first combustion chamber 121 in the combustion state than that of the second combustion chamber 122 in the combustion state, the following methods can be used: the first method is to set a volume of the first fuel bin 51 to 20%-50% of a volume of the second fuel bin 52, so that the first fuel bin 51 has a smaller volume and contains less fuel; the second method is to provide a spacer in the first fuel bin 51, so that the spacer structurally arranges the first fuel bin 51, so that there is less space available for fuels; and the third method is to cause the first fuel bin 51 to have the volume the same as that of the second fuel bin 52, so that fuels with different combustion heat values can be introduced.

Moreover, a plurality of first communication holes 61 are respectively provided on front, rear, left, and right peripheral walls of the combustion box 5, and correspondingly, a plurality of third communication holes 63 are respectively provided on the second separator 32, so that the airflow flowing from a left side of the second air duct 112 to the right can flow through the first fuel bin 51 and the second fuel bin 52 through the first communication holes 61 and the second communication holes 62, and the airflow enters the first fuel bin 51 and the second fuel bin 52 to be directly heated to accelerate heat transfer, and oxygen is supplied to the first fuel bin 51 and the second fuel bin 52 to ensure more complete fuel combustion.

Moreover, in the present embodiment, a plurality of second communication holes 62 are provided on a bottom wall of the combustion box 5, the second communication holes 62 communicate the first fuel bin 51 with the first combustion chamber 121 below the first fuel bin 51, and communicate the second fuel bin 52 with the second combustion chamber 122 below the second fuel bin 52, so that the heat in the first fuel bin 51 and the second fuel bin 52 can be directly diffused by the air to the first combustion chamber 121 below the first fuel bin 51 and the second combustion chamber 122 below the second fuel bin 52, so that the airflow passing through the first combustion chamber 121 below the first fuel bin 51 and the second combustion chamber 122 below the second fuel bin 52 is heated, so that the subsequent mixed airflow has a higher temperature to improve utilization rate of heat energy. In addition, the second communication holes 62 also allow ash generated by combustion to escape from the combustion box 5 to ensure that the fuel in the combustion box 5 is in full contact with the air to improve combustion efficiency.

Specifically, in the present embodiment, the combustion bin 1 is respectively provided with a second bending guide rail 35 extending left and right on front and rear sides of the second air duct 112, and correspondingly, front and rear sides of the combustion box 5 are respectively provided with a second sliding portion 36 adapted to the second bending guide rails 35 in a bending manner, so that the second bending guide rails 35 and the second sliding portions 36 cooperate to perform left and right sliding. In addition, a left side of the combustion bin 1 is provided with a disassembly port 14, so that the combustion box 5 slides leftward and exits the combustion bin 1 from the disassembly port 14 to achieve disassembly, while assembly is achieved by inserting the combustion box into the disassembly port 14 and aligning the second bending guide rails 35 with the second sliding portions 36.

Moreover, in the present embodiment, an ash box 7 is detachably provided below the second air duct 112, and the ash box 7 is fitted to the combustion bin 1 in a pulling manner, which enables collection of ash under the combustion box 5 through the ash box 7, and allows the ash box 7 to be pulled and disassembled from the disassembly port 14, resulting in convenient ash cleaning.

Moreover, in the present embodiment, the ash box 7 is provided with a combustion-supporting member 8 at an upper end thereof, which allows ignition of solid alcohol and other combustion-supporting materials on the combustion-supporting member 8, and then the ash box 7 is inserted into the combustion bin 1, so that the combustion product burned below the combustion zone can efficiently support the combustion of the fuel in the combustion zone, resulting in safe combustion support.

Moreover, in the present embodiment, the combustion-supporting member 8 is a metal stamping member, and the combustion-supporting member 8 includes a support base 81, limiting side walls 82 bent on left and right sides of the support base 81, and hanging portions 83 bent on front and rear sides of the support base 81. In addition, two limiting portions 84 arranged in front and rear are punched on the support base 81, so that a combustion-supporting cavity 85 is formed by the support base 81, the limiting side walls 82 and the limiting portions 84. Therefore, front and rear sides of the combustion-supporting member 8 are hung on the ash box 7 by the two hanging portions 83, and the combustion-supporting material can be added to the combustion-supporting cavity 85 to support combustion.

In addition, the support base 81 and the limiting side walls 82 are respectively provided with fourth communication holes 64 thereon, so that the combustion-supporting cavity 85 is opened in the airflow direction of the second air duct 112, and the airflow continuously supplies oxygen to the combustion-supporting material to ensure more sufficient combustion.

Preferably, in the present embodiment, the combustion bin 1 is provided with a heat-conducting member 15 having a tapered inner circumference at the heat flow outlet 119, so that the heat flow is more concentrated and rapidly discharged upward for heat supply.

### Embodiment II

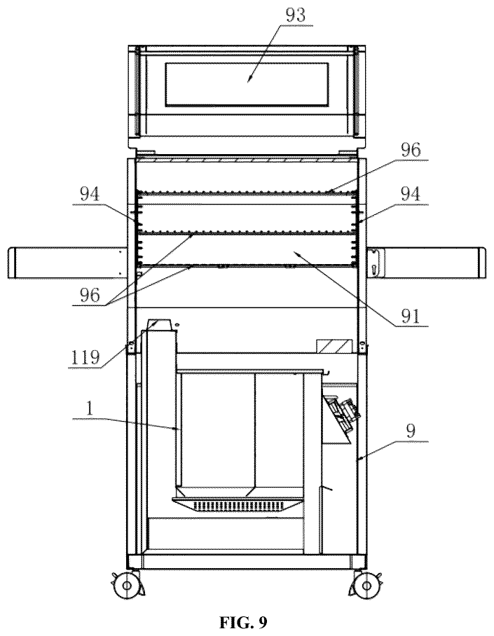

As shown in FIGS. 8 and 9, a grill includes a hob 9 and a multi-zone independent combustion and mixed heat supply combustion device as described in Embodiment I, where the combustion device is arranged in the hob 9, the hob 9 is provided with a braising and roasting cavity 91 above the combustion device, and a heat flow outlet 119 of the combustion device is in communication with the braising and roasting cavity 91.

Therefore, an airflow from the heat flow outlet 119 of the combustion device is directly introduced into the braising and roasting cavity 91 to maintain the braising and roasting cavity 91 at a high temperature to grill the food to be grilled in the braising and roasting cavity 91, and the airflow is continuously introduced into the braising and roasting cavity 91 to quicken and mix the airflow in the braising and roasting cavity 91 to achieve a uniform temperature in the braising and roasting cavity 91 for uniform grilling. Moreover, since different fuels can be fed simultaneously, the combustion of the wood pellets produce the aroma of fruit wood, while the combustion of the charcoal produces a charcoal grilled flavor, and the two flavors are uniformly mixed and enter the braising and roasting cavity 91 with the airflow, and the air flow will uniformly grill the braised food with multiple flavors by supplying heat.

A box cover 93 is hinged on the hob 9, so that the box cover 93 covers the hob 9 to close the braising and roasting cavity 91 or is flipped to open the braising and roasting cavity 91 for grilling operation.

Moreover, a net rack 94 is respectively provided on left and right sides of the braising and roasting cavity 91, and a plurality of vertically arranged support rods 95 are provided on the net racks 94, so that a plurality of grilling nets 96 can be provided to improve grilling efficiency.

### Embodiment III

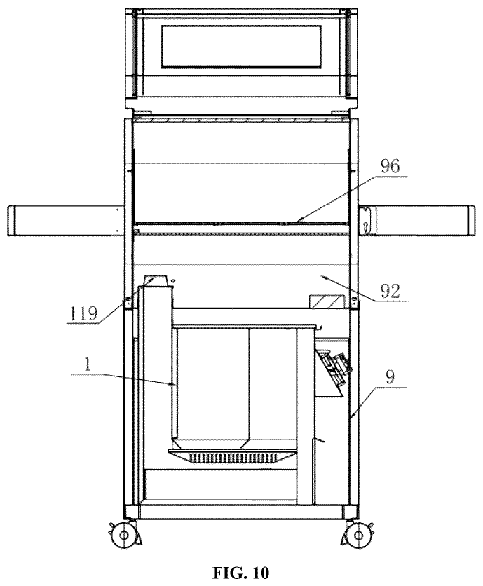

As shown in FIG. 10, a grill includes a hob 9 and a multi-zone independent combustion and mixed heat supply combustion device as described in Embodiment I, where the combustion device is arranged in the hob 9, the hob 9 is provided with a heating cavity 92 above the combustion device and a grilling net 96 located above the heating cavity 92, and a heat flow outlet 119 of the combustion device is in communication with the heating cavity 92.

Therefore, an air flow from the heat flow outlet 119 of the combustion device is introduced into the heating cavity 92 to maintain the heating cavity 92 in a high temperature state, an upper end surface of the heating cavity 92 diffuses heat upward to grill the food on the grilling net 96, and the upper end surface of the heating cavity 92 diffuses heat in the form of a surface area, so that the grilling net 96 is fully covered to grill the food uniformly.

What is claimed is:

1. A multi-zone independent combustion and mixed heat supply combustion device, comprising:
a combustion bin provided with an air duct therein, a first combustion chamber and a second combustion chamber being formed in the air duct, the first combustion chamber and the second combustion chamber being configured for fuel combustion to be heated, and a heat flow outlet being formed at an end of the air duct; and
a blowing device operative to blow an airflow into the air duct, the airflow sequentially passing through the first combustion chamber and the second combustion chamber to be heated to form hot air and being discharged from the heat flow outlet.

2. The multi-zone independent combustion and mixed heat supply combustion device according to claim 1, wherein:
a temperature of the first combustion chamber in a combustion state is lower than a temperature of the second combustion chamber in the combustion state.

3. The multi-zone independent combustion and mixed heat supply combustion device according to claim 2, wherein:
a size of a bin of the first combustion chamber is smaller than a size of a bin of the second combustion chamber.

4. The multi-zone independent combustion and mixed heat supply combustion device according to claim 2, wherein:
a fuel holding density of the first combustion chamber is smaller than a fuel holding density of the second combustion chamber.

5. The multi-zone independent combustion and mixed heat supply combustion device according to claim 2, wherein:
a combustion heat value of a combustion product introduced into the first combustion chamber is lower than a combustion heat value of a combustion product introduced into the second combustion chamber.

6. The multi-zone independent combustion and mixed heat supply combustion device according to claim 2, wherein: the combustion bin is provided with a first upper cavity above the first combustion chamber and a second upper cavity above the second combustion chamber, and the first upper cavity and the second upper cavity are separated; and
the first upper cavity and the second upper cavity are in a sealed configuration so that the airflow is unable to be discharged through the first upper cavity and the second upper cavity.

7. The multi-zone independent combustion and mixed heat supply combustion device according to claim 6, wherein: the air duct comprises a first air duct, a second air duct and a third air duct which are in communicating in sequence, the first air duct and the third air duct are arranged vertically, the second air duct is arranged horizontally, the blowing device blows the airflow into the first air duct, the heat flow outlet is arranged near an end of the third air duct, the first combustion chamber and the second combustion chamber are respectively formed in the second air duct, and the first combustion chamber is located on a side of the second combustion chamber facing the first air duct; and
the first upper cavity and the second upper cavity are formed above the second air duct.

8. The multi-zone independent combustion and mixed heat supply combustion device according to claim 7, wherein: the first air duct is located on a side of the first upper cavity away from the second upper cavity, and the second air duct is located on a side of the second upper cavity away from the first upper cavity.

9. The multi-zone independent combustion and mixed heat supply combustion device according to claim 7, wherein: the combustion bin is provided thereon with a bin cover for opening and closing the first upper cavity and the second upper cavity, and the bin cover is opened for refueling the first upper cavity and the second upper cavity.

10. The multi-zone independent combustion and mixed heat supply combustion device according to claim 7, further comprising a combustion box, wherein the combustion box comprises a first fuel bin located within the first combustion chamber and a second fuel bin located within the second combustion chamber; and
a volume of the first fuel bin is 20%-50% of a volume of the second fuel bin, or the first fuel bin is provided with a spacer therein, or the volume of the first fuel bin is the same as the volume of the second fuel bin.

11. The multi-zone independent combustion and mixed heat supply combustion device according to claim 10, wherein:
the combustion box is provided with a second separator therein for separating the first fuel bin from the second fuel bin.

12. The multi-zone independent combustion and mixed heat supply combustion device according to claim 10, wherein:
a first communication hole is provided on a peripheral wall of the combustion box, and a third communication hole is provided on the second separator.

13. The multi-zone independent combustion and mixed heat supply combustion device according to claim 10, wherein:
a second communication hole is provided on a bottom wall of the combustion box.

14. The multi-zone independent combustion and mixed heat supply combustion device according to claim 6, wherein: the second air duct is detachably provided with an ash box therein, and the ash box is fitted to the combustion bin in a pulling manner; and the ash box is provided with a combustion-supporting member at an upper end thereof.

15. The multi-zone independent combustion and mixed heat supply combustion device according to claim 9, wherein: upper ends of the first air duct, the first upper cavity and the second upper cavity are flush, and the bin cover is arranged covering the upper ends of the first air duct, the first upper cavity and the second upper cavity.

16. The multi-zone independent combustion and mixed heat supply combustion device according to 9, wherein: a height of the first upper cavity and the second upper cavity is 3-10 times a height of the second air duct.

17. A grill, comprising a hob, and a multi-zone independent combustion and mixed heat supply combustion device according to claim 1, wherein the combustion device is arranged on the hob to supply heat.

18. The grill according to claim 17, wherein:
the hob is provided with a braising and roasting cavity thereon, and a heat flow outlet of the combustion device is in communication with the braising and roasting cavity.

19. The grill according to claim 17, wherein:
the hob is provided thereon with a heating cavity and a grilling net located above the heating cavity, and the heat flow outlet of the combustion device is in communication with the heating cavity.
